(19) United States
(12) Patent Application Publication
(10) Pub. No.: US 2005/0246367 A1
(43) Pub. Date: Nov. 3, 2005

(54) Context-driven automated transactions

(76) Inventor: Ralf M. Rath, Mannheim (DE)

Correspondence Address: FISH & RICHARDSON, P.C., PO BOX 1022, MINNEAPOLIS, MN, 55440-1022, US

(21) Appl. No.: 10/837,044

(22) Filed: Apr. 30, 2004

(51) Int. Cl. G06F 7/00

(52) U.S. Cl. 707/102

(57) ABSTRACT

In a business environment, a method for executing context-driven transactions includes defining one or more relations among two or more objects in a semantic network, and defining one or more rules relating to the relations. The “transaction” refers to a request or a sequence of information exchanges for one or more objects. The method includes monitoring the semantic network for changes in any of the objects and relations, and upon detecting a change, automatically triggering a transaction based upon a rule in the system.

### BACKGROUND

The following description relates to automating one or more enterprise services or tasks using a semantic network.

Semantic networks are computer networks that use objects linked together by semantic relations. Semantic networks employ ontologies or topic maps, a description of the concepts and relations, as well as attributes, that exist for a group or its agents. As an example of a relation, documents can relate to authors, and documents belong to topics. As an example of attributes, people can be identified by first and last names, an employee number, or a tax-payer identification number.

The objects within the semantic network define the content of the network. The relations and associations of the objects within the semantic network determine the context of the content. For example, an employee object may be associated with an employee office location object, and has an employee office telephone number, and an employee home address as properties. The employee, office location, and telephone number objects represent the content, and the employee information set, including the relations, represents the context. The context can refer to one or more objects, components, or subsystems that can provide meaning to a system.

Typically, when businesses handle one or more operations from an information technology perspective, the operations are “hardcoded” into the information technology system. In other words, an operation is programmatically built into the system, and cannot be easily modified and/or cannot be modified without extensive changes in the system. The context may be inflexible, and changes to the context may be difficult. In conventional systems, if the changes occur to structures or the “rigid” mappings then the systems may have to be reprogrammed manually. Manual programming can result in increase costs to the system owner, as well as a delay in recording the changes. These changes are also not continually recorded and updated, but rather are updated on a periodic basis or when the amount of changes are so large that the system must be halted to perform the program changes.

### SUMMARY

In one implementation, the present disclosure relates to a computer system for context-driven automated transactions that includes a semantic network with data that forms multiple objects, and at least one relation between pairs of multiple objects, in which each relation defines one or more rules between the pairs, and where the relations and objects form a context for the data. The computer system also includes a monitoring system that monitors the objects and relations, and automatically triggers a transaction upon recognizing a change in any of the rules and/or objects. The transaction includes a change to related objects based on the relations. The relations may include ontologies, links, and mappings.

The system may include a graphical user interface (GUI) to notify a system user of the transaction. The graphical user interface may allow the user to define and/or create any of the objects, rules, relations, and/or context. The system can allow the user to change any of the relations, objects, and context without interfering with a normal operation of the system for other system users.

The semantic network may include a search tool to allow a user to locate similar objects based on a particular context. The semantic network can allow the user to make changes without having an expertise in information technology. The transaction can refer to a computer processing action, a computer processing operation, and/or a sequence of information exchanges based upon a change in the system.

The semantic network may operate in conjunction with one or more operational systems and database systems. The semantic network can surround a topic with the context by relating one or more objects to the topic. The semantic network also may automatically trigger one or more transactions based upon one or more changes in the system. The transaction may be defined with respect to one or more rules and/or with respect to one or more objects.

Also described is a method for executing context-driven transactions that involves defining one or more relations among two or more objects in a semantic network, and defining one or more rules relating to the relations. The method also includes monitoring the semantic network for changes in any of the objects and relations, and upon detecting a change, automatically triggering a transaction based upon a rule in the system. The transaction refers to a request or a sequence of information exchanges for the one or more objects. The relations may include ontologies, links, and/or mappings.

The triggering can perform a computer processing action, a computer processing operation, and/or a sequence of information exchanges based upon the change in the system. The method may involve allowing a user to perform a change based on the triggering without affecting other users of the semantic network. The method also may involve performing one or more changes to the semantic network without disrupting the operation of the network. A change may be made to the network based on the triggering without a requirement for additional substantial network changes.

The current disclosure also describes an article comprising a machine-readable medium storing instructions operable to cause a machine to perform operations involving defining one or more relations among two or more objects in a semantic network, and defining one or more rules relating to the relations. The operations also include monitoring the semantic network for changes in any of the objects and relations, and upon detecting a change, automatically triggering a transaction based upon a rule in the system. The transaction refers to a request or a sequence of information exchanges for the one or more objects. The relations may include ontologies, links, and/or mappings.

The systems and techniques described here may provide one or more of the following advantages. For example, a user of a system can have the flexibility to change the context of a semantic network without changing other parts of the system. The semantic network can have the flexibility and configurability to be easily modified by the user. The user does not need to be an expert in information technology, and does not need to understand all relational aspects of the system to perform changes. The user can define situations that will automatically trigger operations within the system. Objects within the semantic network may be easily found that might have otherwise been difficult to find without the semantic context.

The described system can offer advantages in a dynamically changing environment, such as allowing users who are not information technology expert or professionals to dynamically change a context of objects, relations, and rules and to keep the context up to date with the latest information. The system can have a context that can reflect a current status of information for a business. The status of the information can be monitored for changes. A transaction may be triggered when there are changes in the status. Alternatively, a transaction may automatically trigger changes in the content and/or context. A user can define and modify the context of the semantic network. For example, the user can define rules and transactions. The user can define transactions for frequently performed tasks, such as daily work activities. In another advantage, a user can define a rule for performing multiple tasks. Another potential advantage is that the users can enable the system to make the changes automatically upon the triggering of some event or transaction.

The details of one or more implementations are set forth in the accompanying drawings and the description below. Other features and advantages will be apparent from the description and drawings, and from the claims.

### DRAWING DESCRIPTIONS

FIG. 1A is a block diagram of an information system.

FIG. 1B is a block diagram of a computer architecture system.

FIG. 2 illustrates a semantic network.

FIG. 3 illustrates a semantic network.

FIG. 4 is a diagram of an exemplary transaction.

Like reference symbols in the various drawings may indicate like elements.

### DETAILED DESCRIPTION

The present disclosure describes systems, methods, and techniques in which a semantic network can be used to define a context in an information technology system. The context can be linked or related to a transaction. The context can be dynamically defined based on the transaction without affecting other parts of the information technology system. The context of a transaction may be flexibly changed without changing other objects that are related (directly and/or indirectly) to the system. For example, the information within an organization can form a knowledge base within the company. The knowledge base can be implemented in the semantic network. The context can be defined with respect to dependencies and relations, such as the use and/or type of system for the organization, the knowledge base, or a set of facts or circumstances that surround a situation or event related to the system or organization. A user can start or respond to transactions without having knowledge of all of the dependencies and relations in the context.

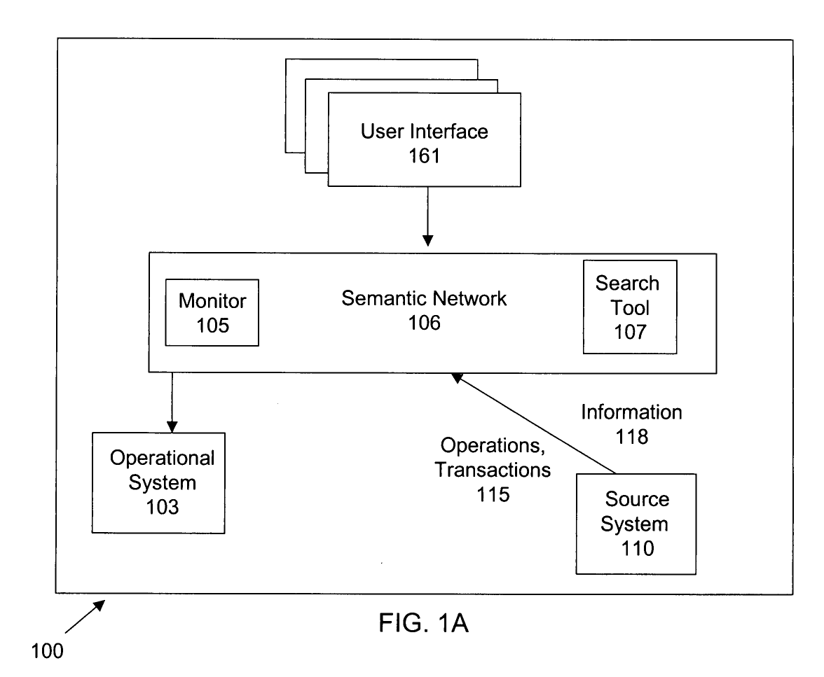

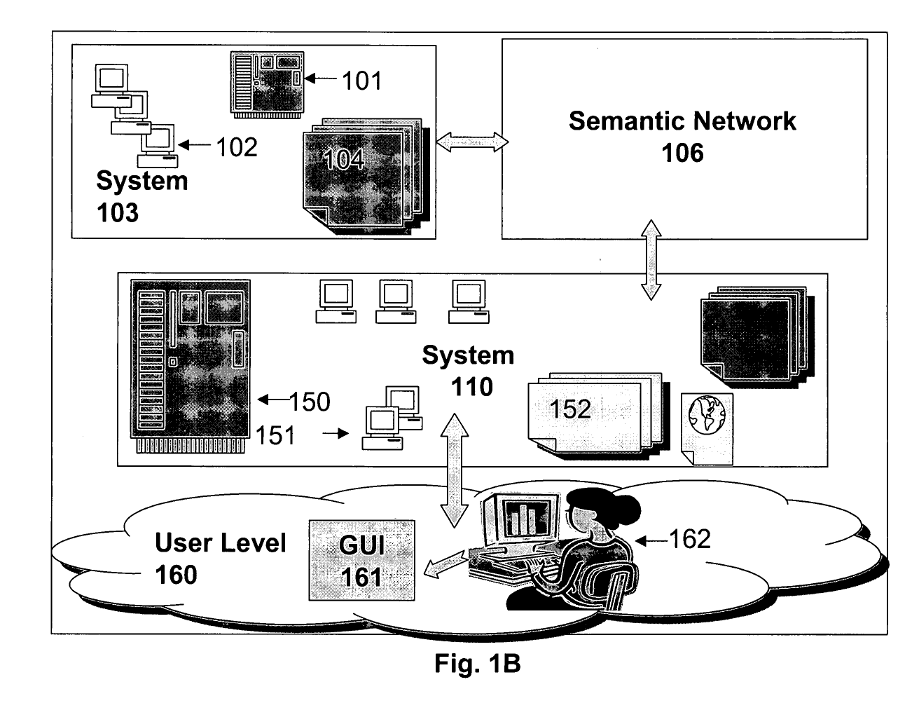

FIG. 1A shows a block diagram of an information system 100 that includes a semantic network 106. The information system 100 may include one or more types of systems, such as database systems, communication systems, human resource systems, supply management systems, and the like. The semantic network 106 uses relational constructions, such as ontologies, to relate information and/or objects. The semantic network can be connected to one or more user interfaces 161. The user interface 161 can be used to define a pattern for a context. The pattern may include one or more steps or actions based on the context. For example, the pattern may include allowing a user to easily identify one or more steps to take for a malfunction of a piece of equipment. The steps may include the information system 100 automatically sending emails to suppliers requesting price quotes for replacement parts, automatically notifying other workers on the production line that the piece of equipment is broken, automatically halting incoming items that uses the machine, and upon receiving price quotes from suppliers, automatically submitting an order for replacement parts.

The semantic network 106 includes objects that are linked to other objects by semantic relations. Each action can be an object that is semantically liked to other objects, and a change to one object can affect its links and all objects to which it is linked. Objects may be presented to the user using the context of the system. For example, an object relating to a basketball can be in the context of sports equipment. In this setup, similar objects may be found or executed by being associated with the context in the semantic network. The semantic network may use a search tool 107 to allow a user to locate similar objects based on a particular context.

The semantic network 106 may function in conjunction with one or more operational systems, such as operational system 103, and/or database systems for information processing. The semantic network 106 may receive information 118, operations and/or transactions 115 from another information source, source system 110.

The operations and transactions 115 refer to a computer processing action or operation in which the semantic network responds to a user request or a condition that was automatically triggered in the context. Each request may be considered a transaction. Alternatively, the “transaction” may refer to a sequence of information exchanges and related work (such as database updating) that is treated as a single unit for the purposes of satisfying a request. The context can be linked or related to the transaction. For example, a context can be a product ordering system, and a transaction can be all or any of the steps in the ordering process and entered into a computer system. For instance, the transaction can include entering the order into an information system, checking an inventory database, confirming that the item is available, placing the order, and confirming that the order has been placed and the expected time of shipment.

The semantic network 106 can surround a particular topic, such as farm machines, with a context by relating one or more objects to the topic, such as relating farm machines to replacement parts, types of farm equipment, the size of the machine, building material for farm machines, suppliers, and vendors.

A user may read, write, and make edits to the information system 100. A user also may make a local version of the semantic network, and may be able to change and update the local version in a local computer system (not shown). The user may be permitted to change the content within the context and define situations where a transaction may be automatically triggered.

In certain cases, the context is monitored using one or more algorithms or programs in a monitoring tool 105. The monitoring tool 105 can determine if there are changes in the context. The programs for monitoring the context may resemble programs that monitor matching patterns. For example, the program may compare a current version of the context to a previous version of the context. Monitoring may be continuous, periodic, or conducted during a system initialization or check. If there are changes in the context, the rules are then checked to see if they are applicable to the changes. In other words, the monitoring tool 105 can verify if the changes in the context will affect the rules. If the changes in the context do affect the rules, then a transaction or operation can be automatically performed. In some cases, a transaction may be proposed to the user, and the user can elect whether to perform the proposed transaction.

FIG. 1B shows an exemplary architectural block diagram of an information system with a semantic network 106. The semantic network 106 may employ one or more graphical user interfaces 161 to allow users 162 to enter information. The semantic network 106 may operate in conjunction with other systems 103, 110. Each computer system 103, 110 may have a repository or database 101, 150 with files, objects, and documents 104, 152 with information that may form a context in a semantic network 106. Objects within the context, for example, may include business news, financial information, reports, analysis, and human resource information. The objects and information may be accessed in a network of computers 102, 151. The semantic network 106 and/or the systems 103, 110 may also be on a physically distributed system, in which information may reside on one or more computers 151 and databases 150, and may be accessed by one or more users 162. In general, the information transmitted to and received between the systems may include one or more of the following: business-specific information, such as sales and customer information; data within objects, spreadsheets, and text files; and business-related applications and logic; relational information, links, connectors, instances, and matching methods.

The computing systems of FIG. 1B can include clients and servers. A client and server are generally remote from each other and typically interact through a communication network. The relation of client and server arises by virtue of computer programs running on the respective computers and having a client-server relation to each other.

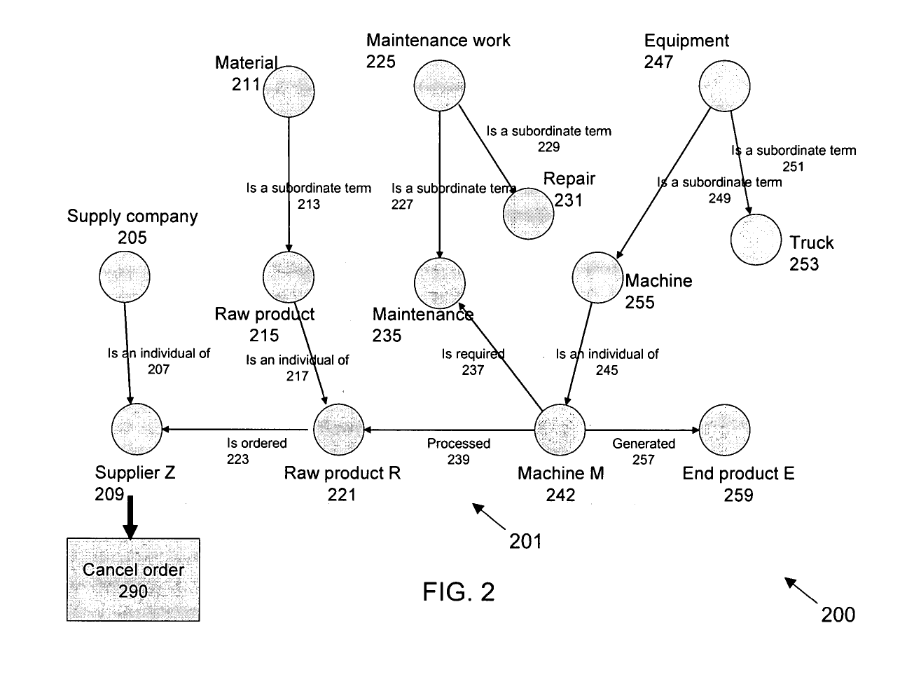

FIG. 2 shows a semantic network 200. In FIG. 2, the nodes represent objects and the lines represent relations. Objects can include business-oriented objects, for example, people, products, projects, customers, topics, organizational units, and the like. By including business-oriented objects in a semantic network, process-driven and content-based contexts can be mapped. Process-driven contexts can be defined in terms of achieving one or more transactions, such as a context for receiving and fulfilling orders. The content-based context may be created by linking these objects. For example, not only similar documents are presented to the user, but also their associated attributes, such as an author's name and the author's email address. The context can be defined using a semantic network, for example as a combination of an object, the object's relation, and any other relations (direct or indirect) to that object.

The semantic network 200 may be dynamic. For example, if the suppliers do not have available replacement parts for the machine, the user may define a pattern to include contacting repair personnel as a contingency plan. For example, if the semantic network 200 changes, the relations defined in the network may also change. The semantic network 200 may have a map of relations referred to as a semantic map, a knowledge map, or a topic map. The map of relations can define a working environment of a user or a group of users.

Abstract rules can be formulated using subordinate (and/or superordinate) terms and “instance of” relations. A rule for machines could automatically affect all instances of subordinate terms and analogous relations. For example, a company may be in a wood-working industry. The equipment object 247 represents the superordinated term to all machines 255, 242 and trucks 253 of the company. The company may own Machine M 242 and machine 255, in which Machine M 242 is a part of machine 255. So, the machines 242, 255 and the truck 253 belong to the equipment 247 that is owned by the company. An individual machine M 242, such as a wood cutter, is linked with the “is individual of” relation to another machine, such as the relation 245 to machine 255.

Machine M 242 refers to an instance of a wood cutting machine that cuts a stump (raw product 221) into one or more wood planks (end product 259). The supplier Z 209 can be a lumberjack company that delivers the stump (raw product 221). If the wood cutting machine (Machine M 242) needs a new saw blade, the machine requires maintenance work 225. As a result of the maintenance work 225, Machine M 242 is related to the maintenance object 235. In another example, if the truck 253 needs a repair, the instance of the truck 253 can be related to the “Repair” object 231.

In FIG. 2, the semantic network shows relations in the context of business equipment, such as machinery for a factory. A user can define an event, rule, or condition to trigger a context transaction. The user can classify one or more activities in a schema, and define the context for the transaction triggering. When the user receives a proposal for a transaction, the user can manually accept the transaction. Alternatively, when the user receives a proposal for a transaction, the transaction can be performed automatically in case of a prior or pre-defined agreement.

In FIG. 2, the transaction includes canceling an order 290. In this example, the shaded portion 201 represents the context for the transaction of “cancel order” 290. In one scenario, maintenance is required for machine M 242. A transaction for the context can be defined for the scenario of “the wood cutter (242) has down time, cancel the order for the raw product” using objects 242, 235, 221, 209.

The machine M 242 is used to generate (block 257) an end product E 259, such as a wood cutting machine that generates one or more planks. The machine M 242 processes (block 239) raw product R 221, such as wood stumps. The raw product R 242 is typically ordered (block 223) from supplier Z 209. The supplier Z 209 is an instance of a supply company 205. For example, the supplier Z 209 is an independent lumberjack. When maintenance is required for the machine M 242, the rules in the context are checked, and the semantic network can trigger the transaction of canceling an order 290. In this example, the machine may be under repair for one week. In that case the company cannot store the raw material and, the supplier Z 290 may be notified to immediately cancel all orders of wooden stumps.

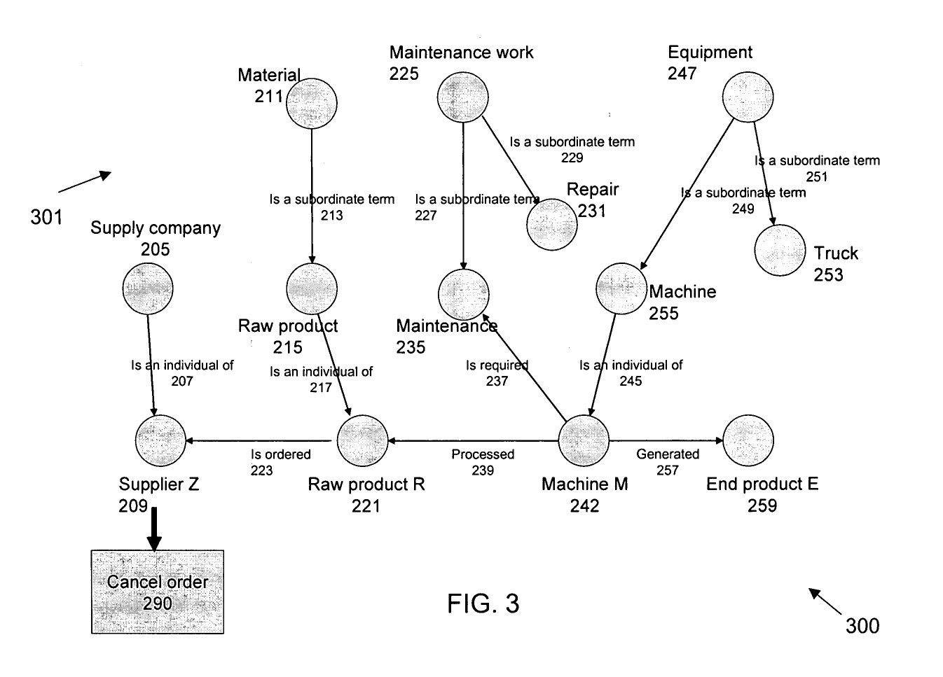

Another network schematic example is shown in FIG. 3, in which the shaded portion 301 shows the context for a rule. The definition of the rule for the context includes the equipment 247, maintenance work 225, and materials 211, as well as the supply company 205. In one scenario, the equipment 247, which includes machines 242, 255 and truck 253 of the company, may have downtimes for maintenance work 225 (repair 231 or maintenance 235). The maintenance scenarios for the equipment 247 are covered by the rule for the context. In that scenario, orders from suppliers are cancelled. In another example, the truck 253 may need to be repaired 231. A material 211 in the context includes fuel for the truck. So if the truck 253 needs to be repaired 231, the fuel order will be cancelled from the fuel supplier.

In general, the user can define a context and relate or link a transaction to a context. A change in the context or the rules of the context can trigger a transaction. Other contexts may be more complex than shown in FIGS. 2 and 3. Complex contexts may be defined using a list of simple context, such as a list of an “object”+“relation”+“another object”.

The transaction may be programmed to occur in a conditional relation, such as an “if . . . then” relation condition. For example, if end product E 259 is not meeting a target selling goal then order less raw product R from the Supplier Z 209. The transaction may be defined by the rules or defined by the object that relates to those rules. In this example, the rules may include the production of the end product, and the object can refer to the end product 259.

Nevertheless, it will be understood that various modifications may be made without departing from the spirit and scope of the claims below. For example, FIG. 2 may have a different context, and may have relations that overlap with another context. For example, one context may be a retail store, and a second context is a human resource context. The overlapping relation between the contexts may involve adjusting headcount with seasonal sales activity.

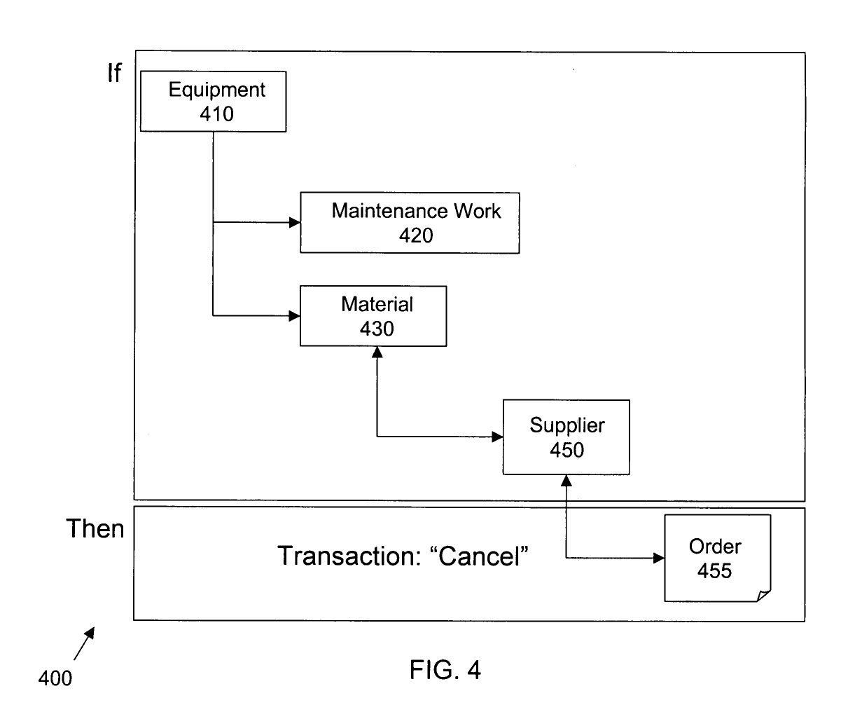

FIG. 4 shows an example of a rules-based definition 400 in an ordering context for a piece of equipment 410. The material 430 and the supplier 450 may be linked because the supplier provides the material 430. The order 455 and the supplier may be linked because the supplier can fulfill the order 455. The rules-based definition 400 may be the following: “If a piece of equipment 410 fails then cancel the orders 455 from the supplier 450 for the objects 430 required for normal operation of that machine, and submit a request for maintenance work 420.” The piece of equipment 410 can be a machine or truck, and the objects 430 required for the normal operation of that machine can include raw materials, fuel, and waste removal.

Although only a few implementations have been described in detail above, other modifications are possible. Accordingly, other implementations are within the scope of the following claims.

1. A computer system for context-driven automated transactions comprising:
a semantic network comprising data that forms a plurality of objects;
at least one relation between pairs of the plurality of objects, wherein each relation defines one or more rules between the pairs, and wherein the relations and objects form a context for the data; and
a monitoring system that monitors the objects and relations, and automatically triggers a transaction upon recognizing a change in any of the rules or objects, wherein the transaction includes a change to related objects based on the relations.

2. The system in accordance with claim 1, wherein the relations comprise any of ontologies, links, and mappings.

3. The system in accordance with claim 1, further comprising a graphical user interface to notify a the system user of the transaction.

4. The system in accordance with of claim 3, wherein the graphical user interface is adapted to allow the user to define any of the objects, rules, relations, and context.

5. The system in accordance with claim 1, further comprising a graphical user interface is that allows a user to create a relation.

6. The system in accordance with claim 1, wherein the user is adapted to change any of the relations, objects, and context without interfering with a normal operation of the system for other system users.

7. The system in accordance with claim 1, wherein the semantic network comprises a search tool to allow a user to locate similar objects based on a particular context.

8. The system in accordance with claim 1, wherein the semantic network is adapted to allow the user to make changes without having an expertise in information technology.

9. The system in accordance with claim 1, wherein the transaction refers to any of a computer processing action, a computer processing operation, and a sequence of information exchanges based upon a change in the system.

10. The system in accordance with claim 1, wherein the semantic network is adapted to operate in conjunction with one or more operational systems and database systems.

11. The system in accordance with claim 1, wherein the semantic network is adapted to surround a topic with the context by relating one or more objects to the topic.

12. The system in accordance with claim 1, wherein the semantic network automatically triggers a plurality of transactions based upon one or more changes in the system.

13. The system in accordance with claim 1, wherein the transaction is defined with respect to one or more rules.

14. The system in accordance with claim 1, wherein the transaction is defined with respect to one or more objects.

15. A method for executing context-driven transactions comprising:
defining one or more relations among two or more objects in a semantic network;
defining one or more rules relating to the relations;
monitoring the semantic network for changes in any of the objects and relations; and
upon detecting a change, automatically triggering a transaction based upon a rule in the system, wherein the transaction refers to a request or a sequence of information exchanges for the one or more objects.

16. The method in accordance with claim 15, wherein the relations comprise any of an ontology, a link, and a mapping.

17. The method in accordance with claim 16, wherein the triggering performs any of a computer processing action, a computer processing operation, and a sequence of information exchanges based upon the change in the system.

18. The method in accordance with claim 16, further comprising allowing a user to perform a change based on the triggering without affecting other users of the semantic network.

19. The method in accordance with claim 16, further comprising performing one or more changes to the semantic network without disrupting the operation of the network.

20. The method in accordance with claim 19, further comprising making a change to the network based on the triggering without a requirement for additional substantial network changes.

21. An article comprising a machine-readable medium storing instructions operable to cause a machine to perform operations comprising:
defining one or more relations among two or more objects in a semantic network;
defining one or more rules relating to the relations;
monitoring the semantic network for changes in any of the objects and relations; and
upon detecting a change, automatically triggering a transaction based upon a rule in the system, wherein the transaction refers to a request or a sequence of information exchanges for the one or more objects.
